(19) United States
(12) Patent Application Publication
(10) Pub. No.: US 2016/0179150 A1
(43) Pub. Date: Jun. 23, 2016

(54) THERMAL MANAGEMENT METHOD AND ELECTRONIC SYSTEM WITH THERMAL MANAGEMENT MECHANISM

(71) Applicant: MEDIATEK INC., Hsin-Chu, (TW)

(72) Inventors: Tsu-Ming Liu, Hsinchu City (TW); Tsui-Shan Chang, Tainan City (TW); Chi-Cheng Ju, Hsinchu City (TW); Chih-Ming Wang, Hsinchu County (TW)

(21) Appl. No.: 14/908,116

(22) PCT Filed: Jun. 12, 2015
(86) PCT No.: PCT/CN2015/081373

§ 371 Date: Jan. 27, 2016

Related U.S. Application Data
(60) Provisional application No. 62/011,189, filed on Jun. 12, 2014.

(51) Int. Cl. G06F 1/20; G05B 15/02

(52) U.S. Cl. CPC G06F 1/206; G05B 15/02

(57) ABSTRACT

Disclosed is an electronic system with a thermal control mechanism, comprising: an image/video processing module (101), configured to process at least one image or video data; a parameter acquiring device (103), configured to acquire at least one device parameter corresponding to a first device of the image/video processing module (101); and a thermal management device (105), configured to adjust at least one operating parameter for a second device of the image/video processing module (101) according to the device parameter to control a temperature of the image/video processing module (101).

### CROSS REFERENCE TO RELATED APPLICATIONS

This application claims the benefit of U.S. Provisional Application No. 62/011,189, filed on Jun. 12, 2014, the contents of which are incorporated herein by reference.

### BACKGROUND

The temperature for an electronic apparatus is highly regarded, since a high temperature may affect the performance of the electronic apparatus, or makes the user feel un-comfortable, or even burns the user.

Therefore, the temperature of the electronic apparatus should be carefully controlled. For example, following IEC 62368-1, Audio/Video, Information Technology and Communication Technology Equipment—Part 1: Safety Requirement, the touch temperature limit for touchable surfaces is 48° C.

However, if the temperature of the electronic apparatus is desired to be decreased, the whole performance of the electronic apparatus is always suppressed to decrease the temperature.

### SUMMARY

Therefore, one objective of the present invention is to provide a thermal management method can adjust only few devices of the electronic system to control the temperature.

Another objective of the present invention is to provide an electronic system that can adjust only few devices thereof to control the temperature.

One embodiment of the present application is to provide a thermal management method comprising: (a) acquiring at least one device parameter for at least one first device of the image/video processing module; and (b) adjusting at least one operating parameter for at least one second device of the image/video processing module according to the device parameter to control a temperature of the image/video processing module.

Another embodiment of the present application is to provide an electronic system with a thermal control mechanism, which comprises: an image/video processing module, configured to process at least one image or video data; a parameter acquiring device, configured to acquire at least one device parameter for at least one first device of the image/video processing module; and a thermal management device, configured to adjust at least one operating parameter for at least one second device of the image/video processing module according to the device parameter to control a temperature of the image/video processing module.

In view of above-mentioned embodiments, the temperature can be controlled via adjusting only a few devices, thus the performance for whole electronic apparatus would not greatly decrease.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating an electronic system applying a thermal management method according to one embodiment of the present invention.

FIG. 2 is a block diagram illustrating detail structures for the parameter acquiring device depicted in FIG. 1, according to one embodiment of the present invention.

FIG. 3 is a block diagram illustrating detail structures for the thermal management device depicted in FIG. 1, according to one embodiment of the present invention.

FIG. 4 is a block diagram illustrating detail structures for the image/video processing module depicted in FIG. 1, according to one embodiment of the present invention.

FIG. 5 is a flow chart illustrating a thermal management method according to one embodiment of the present invention.

FIG. 6-FIG. 19 are schematic diagrams illustrating examples that the thermal management method provided by the present invention is applied to the image/video processing module depicted in FIG. 4.

FIG. 20 is a block diagram illustrating detail structures for the image/video processing module depicted in FIG. 1, according to another embodiment of the present invention.

FIG. 21-FIG. 32 are schematic diagrams illustrating for examples that the thermal management method provided by the present invention is applied to the image/video processing module depicted in FIG. 4.

### DETAILED DESCRIPTION

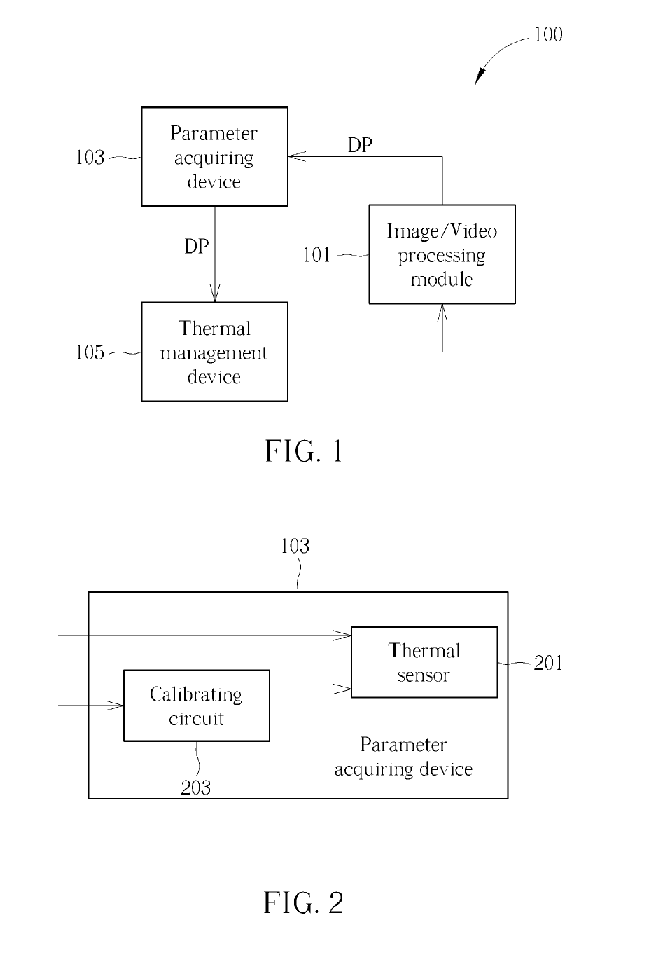

FIG. 1 is a block diagram illustrating an electronic system applying a thermal management method according to one embodiment of the present invention. The electronic system may be a mobile device or any other device with image/video processing ability. As illustrated in FIG. 1, the electronic system 100 comprises an image/video processing module 101, a parameter acquiring device 103 and a thermal management device 105. The image/video processing module 101 is a module that can process at least a single image (e.g. a still image) or video data (e.g. video stream) comprising a plurality of images. The operation of processing the single image or the video data may comprises at least one of following operations: encoding the still image, decoding the still image, encoding the video data, decoding the video data. The operation of processing the single image or the video data may further comprises the operations for processing decoded/encoded still image or video data. In some embodiments, the decoded/encoded still image or video data may be stored to the memory device, or the decoded/encoded still image or video data may be read from the memory device. In some other embodiments, the decoded/encoded still image or video data may be provided for display.

The parameter acquiring device 103 can acquire at least one device parameter DP corresponding to a first device in the image/video processing module 101. The thermal management device 105 adjusts at least one operating parameter for a second device of the image/video processing module 101 according to the device parameter DP. In one embodiment of this invention, the thermal management device 105 may perform such adjustment without adjusting any setting or configuration of a central processing unit (CPU) of the electronic system 100. In another embodiment of this invention, the thermal management device 105 may further perform such adjustment to the setting or configuration of the CPU of the electronic system 100. Please note the first device and the second device can be the same device, and can be different devices as well. For example, the first device and the second device are the same memory device. Alternatively, in another example, the first device is a single image decoder, but the second device is a display processor. In some other embodiments, if the number of the first device or the second device is more than one, part of the device may be the same.

The device parameter DP may include a consequence parameter representing or indicating its temperatures, for example, a temperature, a current value, power consumption, a signal delay value which is related to temperature variation, or any other kind of consequence parameter related to temperatures. In such example, directly according to the device parameter DP, the thermal management device 105 adjusts the operating parameter. In some embodiments, the relation between the temperature variation and the signal delay value may be utilized. For example, the signal delay for an inverter chain may be dependent upon temperature. In detail, the signal delay for the inverter chain may increase as the temperature increases. Accordingly, the temperature may be determined based on a measured signal delay of an inverter chain of the first device.

Alternatively, the device parameter DP may include a configuration parameter related to the temperature, for example, a frame rate, an exposure value, a frame resolution, an operating speed, or any other kind of configuration parameter related to the temperature. In such example, the thermal management device 105 may compute or anticipate the temperature related value according to the device parameter DP first, and then adjusts the operating parameter accordingly. However, directly according to the configuration parameter DP, the thermal management device 105 may also adjust the operating parameter.

Corresponding to different device parameters, the parameter acquiring device 103 may comprise different structures or configurations. For example, if the device parameter DP includes a temperature, the parameter acquiring device 103 may include a thermal sensor. Also, if the device parameter DP includes a frame rate, the parameter acquiring device 103 may access the settings or configurations for the first device in the image/video processing module 101. For example, access configuration of the frame rate in a decoder in the image/video processing module 101.

The operating parameter to be adjusted may include an operating speed, any configuration parameter (such as a frame rate, an exposure value, a frame resolution, a brightness value, an operating voltage or any other configuration parameter), any parameter about operating the second device, or combination thereof.

Please note the device parameter DP and the operating parameter are not limited to above-mentioned examples. Further examples for the device parameter DP and the operating parameter will be explained later.

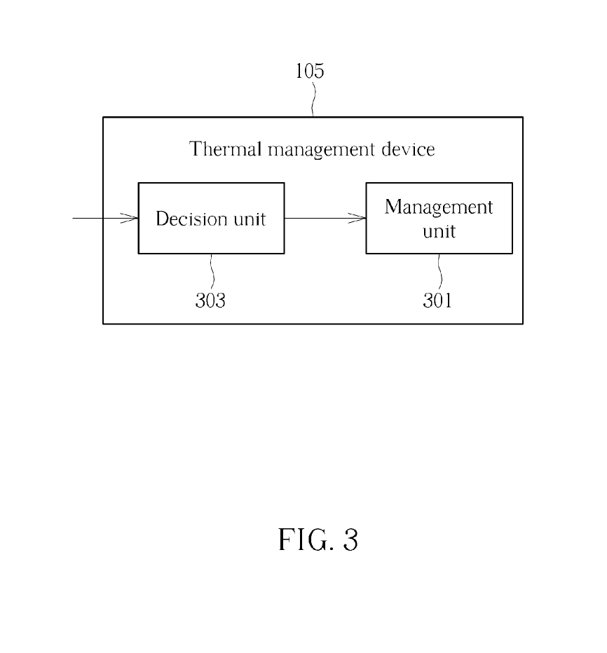

FIG. 2 is a block diagram illustrating detail structures for the parameter acquiring device 103 depicted in FIG. 1, according to one embodiment of the present invention. In this embodiment, the parameter acquiring device 103 may include a thermal sensing module, which can sense a parameter representing or indicating temperatures, for example, a temperature, a current value, a signal delay value which is related to temperature variation or any other value related to the temperature. The parameter acquiring device 103 may include a thermal sensor 201, which directly senses the device parameter corresponding to the device in the image/video processing module. In some embodiments, the thermal sensor 201 may include an inverter chain which is temperature dependent. In one embodiment, the parameter acquiring device 103 further comprises a calibrating circuit 203, which is configured to minimize the measurement errors. The calibrating circuit 203 may be performed according to environmental temperature or information about the type of thermal sensor 201. In some embodiments, the calibration may be realized by table-look-up via off-line process. In some other embodiments, the calibration may be implemented via external thermometer or internal logic.

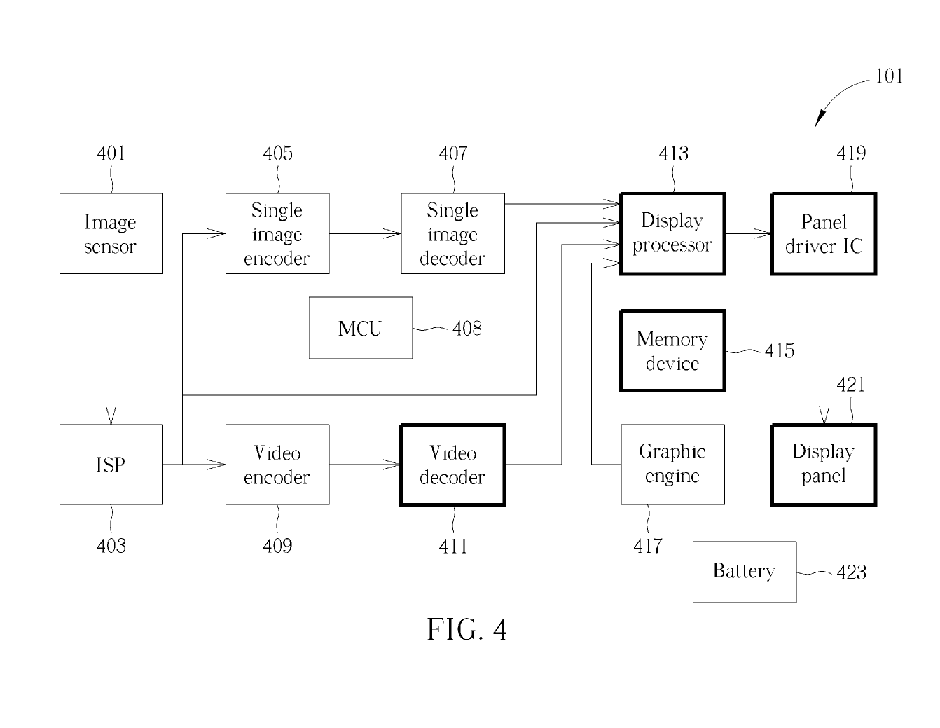

FIG. 3 is a block diagram illustrating detail structures for the thermal management device 105 depicted in FIG. 1, according to one embodiment of the present invention. In this embodiment, the thermal management device 105 comprises a management unit 301 and a decision unit 303. The decision unit 303 is configured to determine if the management unit 301 should be enabled or not according to received parameters. For example, if the decision unit 303 receives a temperature, a current value or a value representing or indicating the temperature is higher than a corresponding threshold value, the decision unit 303 enables the management unit 301 to start thermal management.

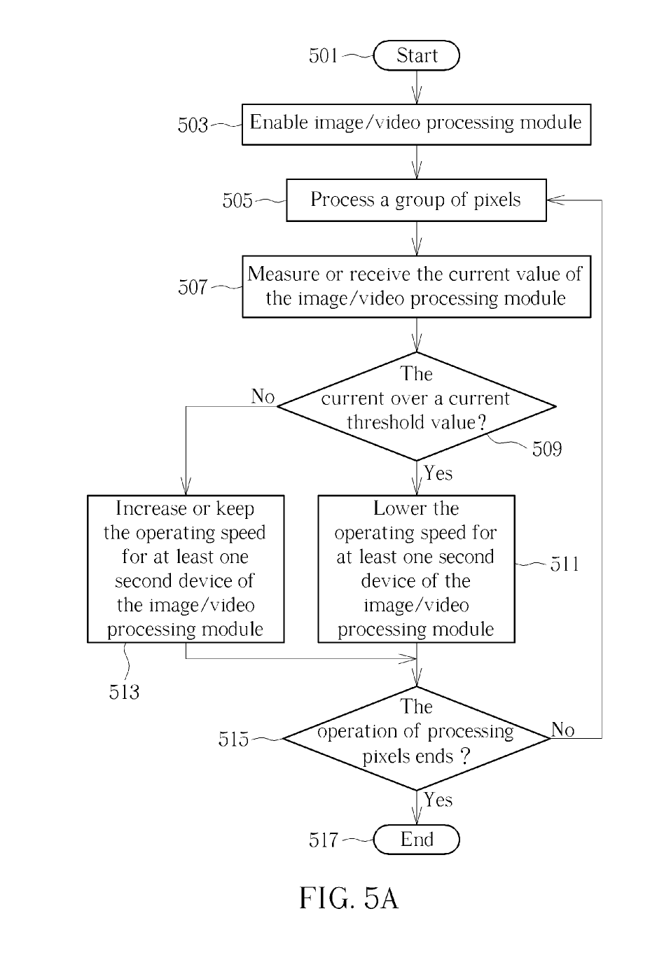

FIG. 4 is a block diagram illustrating detail structures for the image/video processing module depicted 101 in FIG. 1, according to one embodiment of the present invention. As shown in FIG. 4, the image/video processing module 101 may comprise at least one of an image sensor 401, an image signal processor 403, a single image encoder 405, a single image decoder 407, a micro control unit 408, a video encoder 409, a video decoder 411, a display processor 413, a memory device 415, a graphic engine 417, a panel driver IC 419, a display panel 421, a battery 423, or combination thereof.

The image sensor 401 is configured to sense images (e.g. taking pictures). The image signal processor 403 is configured to process image signals from the image sensor 401. The single image encoder 405 and the single image decoder 407 are applied to process independent images (e.g. pictures) for image encoding and decoding respectively. Also, the micro control unit 408 is configured to control the operations for devices in the image/video processing module 101. The video encoder 409, the video decoder 411 are applied to process video data comprising a plurality of images (e.g. video stream) for video encoding and decoding respectively. The display processor 413 is configured to process images or video data from the image signal processor 403, the single image decoder 407 the video decoder 411 or the graphic engine 417, to generate images or video data that can be displayed on the display panel 421. The memory device 415 (e.g. a DRAM) is configured to store images or video data, and the stored images or video data can be accessed and displayed on the display panel 421. The graphic engine 417 is configured to draw an image. The panel driver IC 419 is configured to drive the display panel 421.

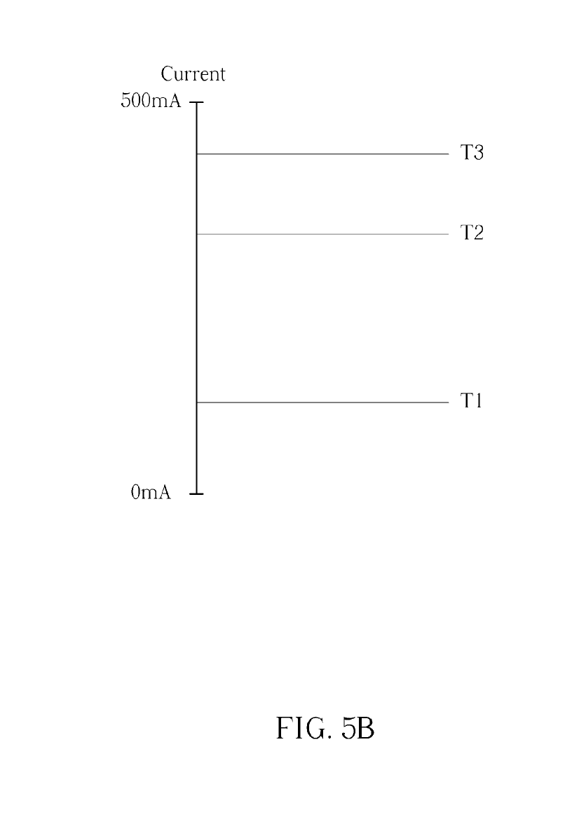

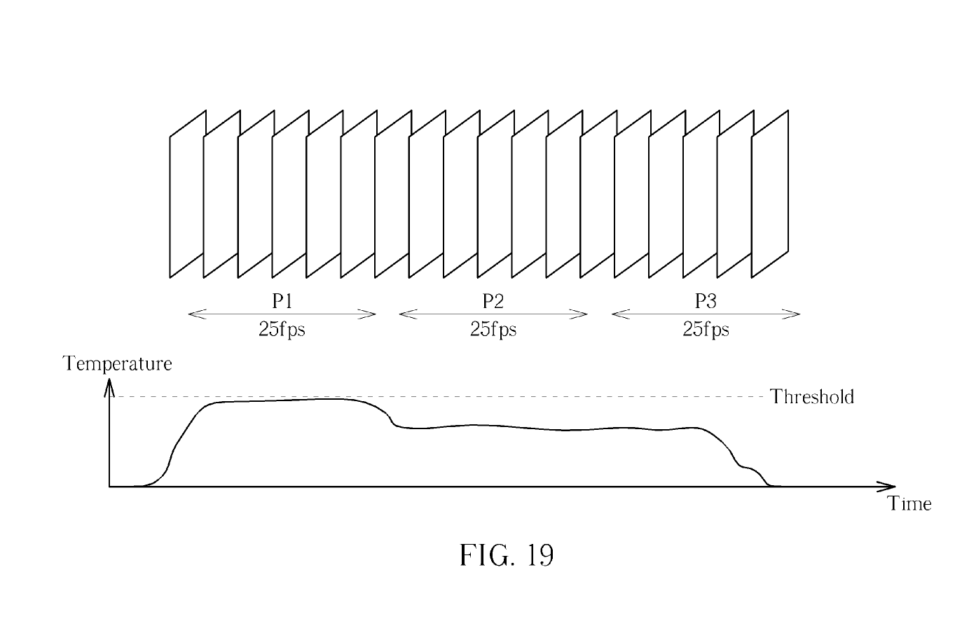

If the image/video processing module 101 is applied to process video data, the devices that tend to generate thermal may include: the video decoder 411, the display processor 413, the memory device 415, the panel driver IC 419, the display panel 421 or combination thereof. Therefore, these devices are applied as examples in the embodiments depicted in FIG. 5A,5B-FIG. 19. Please note these examples are only for explaining and do not mean to limit the scope of the present invention.

FIG. 5A is a flow chart illustrating a thermal management method according to one embodiment of the present invention. The flow chart in FIG. 5A comprises:

Step 501

Start

Step 503

Image/video processing module 101 may be enabled.

Step 505

Process a group of pixels (e.g. decode). The pixels can be received from the memory device 415, or from any other source inside or outside the image/video processing module 101.

Step 507

Measure or receive the current value (i.e. the above-mentioned device parameter) of the image/video processing module 101. Please note, in some embodiments of step 507, the current value for only one first device of the image/video processing module 101 may be measured or received, or a current amount for several first devices of the image/video processing module 101 may be measured or received. In some embodiments of step 507, if the image/video processing module 101 is enabled to process video data, the current value for the video decoder 411, the display processor 413, the memory device 415 or combination thereof may be measured or received. In some other embodiments of the step 507, the current value of the battery may be measured or received to represent the current value of the image/video processing module 101.

Step 509

Determine if the current measured or received in the step 507 is over a current threshold value or not. If yes, go to step 511, if not, go to step 513.

Step 511

Lower the operating speed (i.e. the above-mentioned operating parameter) for a second device of the image/video processing module 101. In one embodiment of step 511, the second device of the image/video processing module 101 may mean at least one of: the video processor 411, the display processor 413, the memory device 415, the panel driver IC 419 and the display panel 421.

Step 513

Increase or keep the operating speed for a second device of the image/video processing module 101. In one embodiment of step 513, the second device of the image/video processing module 101 may mean at least one of: the video processor 411, the display processor 413, the memory device 415, the panel driver IC 419 and the display panel 421.

In one embodiment, several current threshold values can be provided, such as FIG. 5B. In such embodiment, the step 511 is performed according to which range the current value measured or received in the step 507 locates in. For example, if the current value is above the current threshold value T1 but below the current threshold value T2, the step 511 lower the operating speed to a first level. Also, if the current value is above the current threshold value T2 but below the current threshold value T3, the step 511 lower the operating speed to a second level lower than the first level.

Step 515

If the operation of processing pixels ends may be determined. If yes, go to step 517, if not, go back to the step 505.

Step 517

End.

Since the current measured or received in the step 507 is a parameter representing or indicating the temperature, thus the step 507 can be regarded as an embodiment for “acquiring device parameter representing or indicating temperature”. In other embodiments, a temperature, a current value, a signal delay value which is related to temperature variation, any other device parameter representing or indicating the temperature or combination thereof may be acquired.

In another embodiment, the step 507 is replaced with a step for “acquiring device parameter related to the temperature”. For example, acquire a frame rate, an exposure value, a frame resolution, an operating speed, or any other parameter related to the temperature. In such embodiment, the step 509 is correspondingly replaced by another step. For example, if the step 507 is replaced by a step of acquiring a frame resolution, the step 509 is replaced by a step of “determining if the frame resolution is over a resolution threshold value”.

For such embodiment, several resolution threshold values may be provided as well. As shown in following Table 1, several resolution threshold values are provided, and the operating speed may be adjusted to different values corresponding to which range the frame resolution located in. For example, but not limitation, when resolution is high, temperature may also go high. Therefore, when resolution is high, a low operating speed is set.

TABLE 1

| Resolution | |
|---|---|
| threshold | Adjustment |
| 1920 × 1080 | Operating speed level 1 |
| 4096 × 2160 | Operating speed level 2 |
| 7680 × 4320 | Operating speed level 3 |

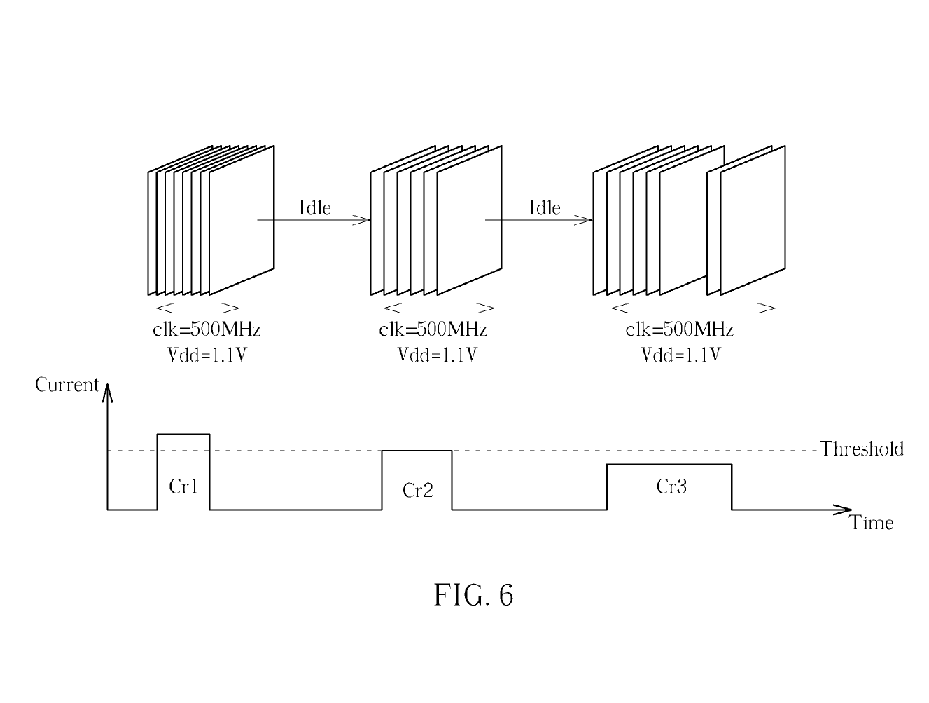

FIG. 6-FIG. 19 are schematic diagrams illustrating for examples that the thermal management method provided by embodiments of the present invention are applied to the image/video processing module depicted in FIG. 4. In the embodiments of FIG. 6-FIG. 8, the operating speed for at least one second device of the image/video processing module is adjusted via adjusting the clock rate thereof, based on the current value. FIG. 6 illustrates an embodiment of the situation that the operating speed is not adjusted. As shown in FIG. 6, the clock rates are all 500 MHz for different periods, and the current value Cr1 is particularly high and over a current threshold value, which may cause a high temperature. Please note the current value can be a peak current value for a period, or an average current value for a period.

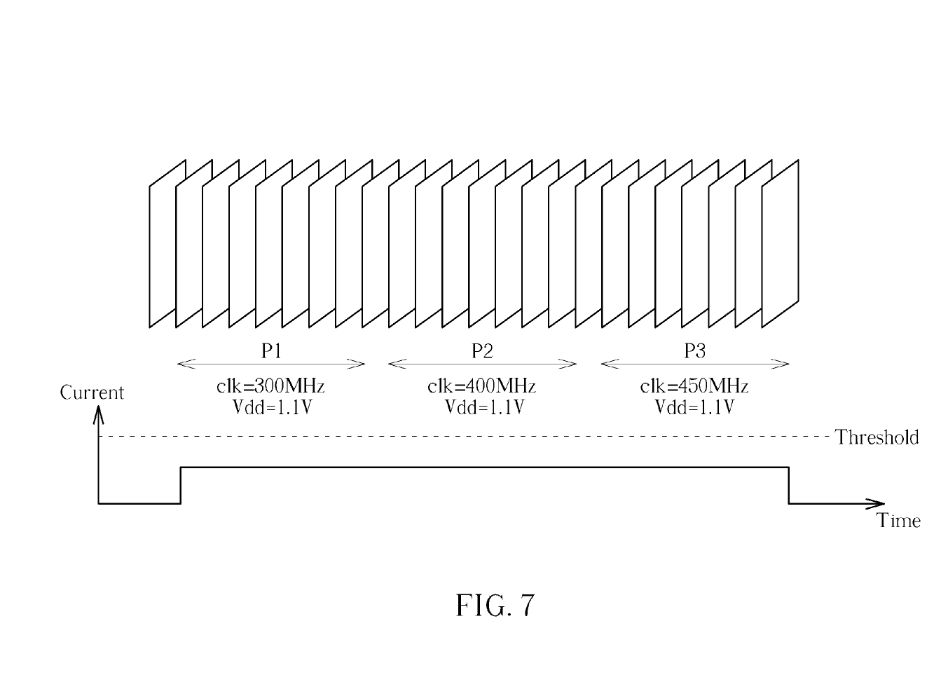

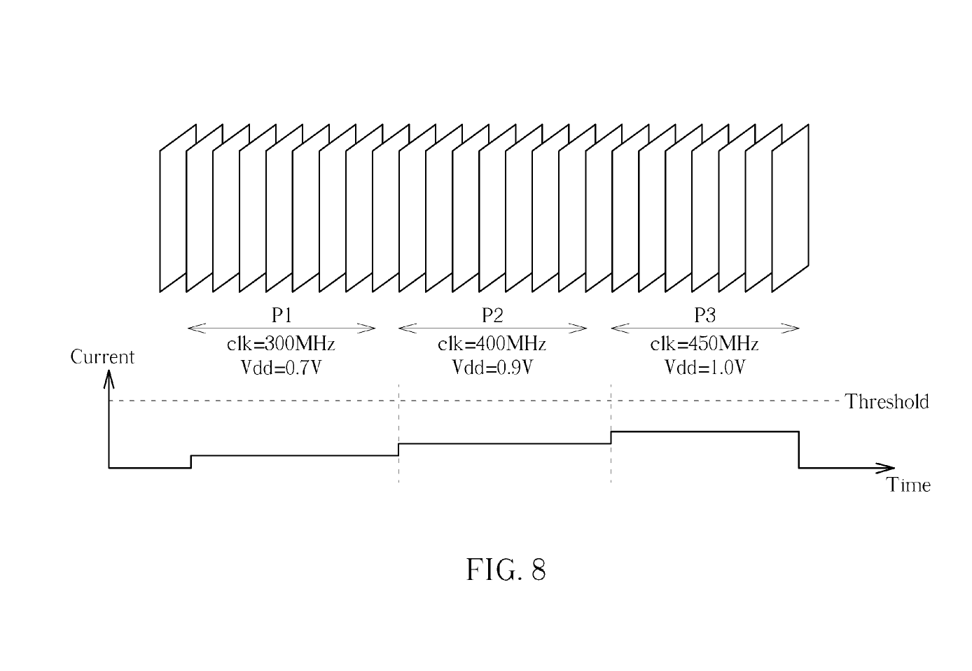

In FIG. 7, the clock rates for all periods P1, P2. P3 are adjusted (not limited to all periods, however), thereby the current for each period P1, P2, P3 is lower than a current threshold value. In FIG. 8, the clock rates are adjusted with lowered Vdd, thereby that the average current for each period P1, P2, P3 is further reduced. Please note the embodiments depicted in FIG. 7 and FIG. 8 can be independently applied or simultaneously applied.

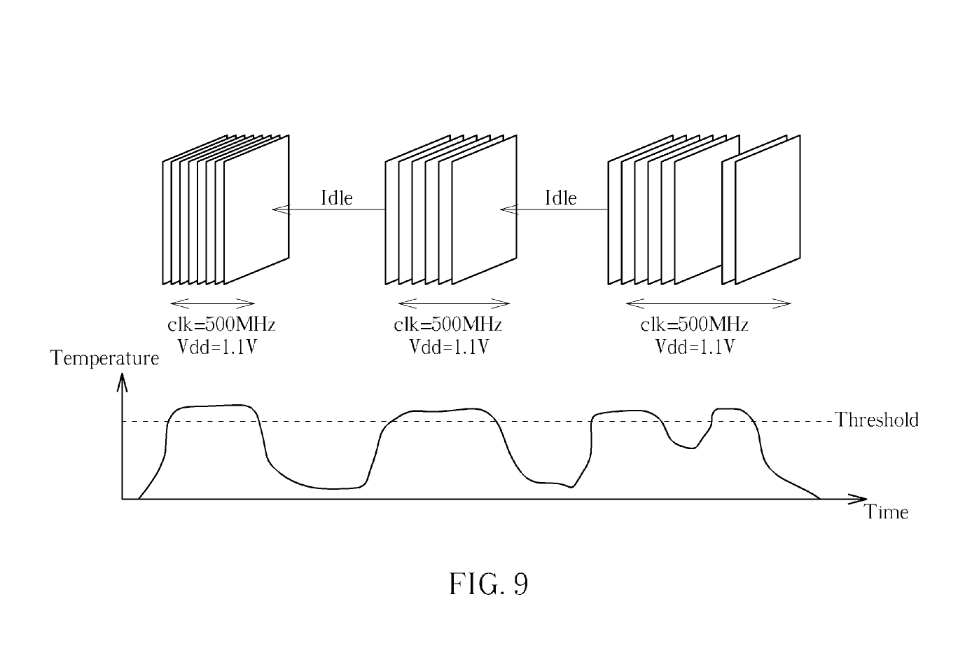

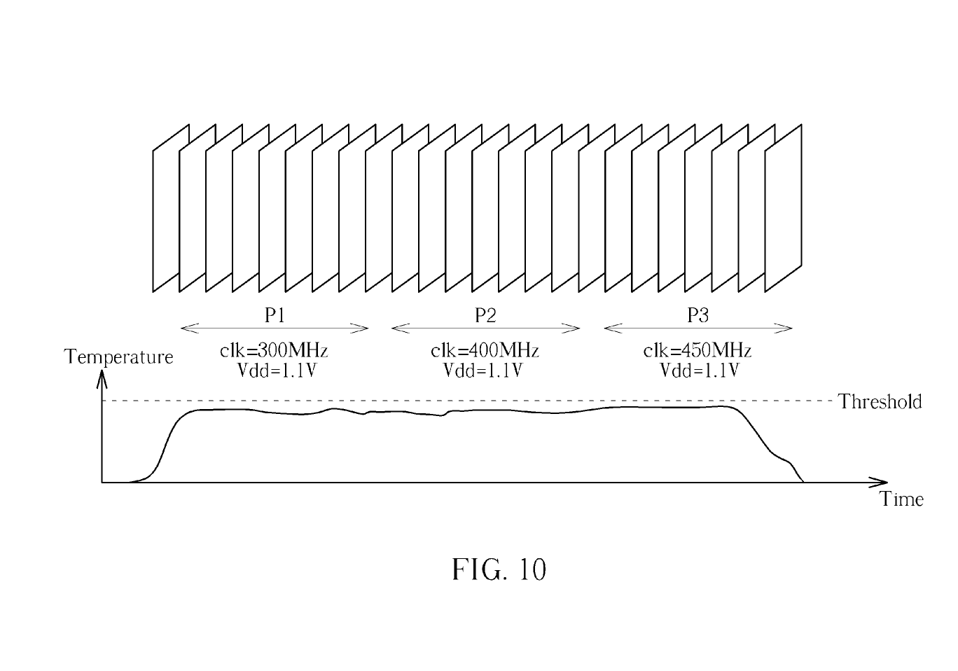

FIG. 9 and FIG. 10 are schematic diagrams of some embodiments illustrating the clock rate is adjusted based on temperature. In FIG. 9, the clock rate is not adjusted, thus the temperature has a high value over a temperature threshold value. In FIG. 10, the clock rates for all periods P1, P2, P3 are adjusted (not limited to all periods, however), such that the temperature is reduced to be lower than the temperature threshold value correspondingly.

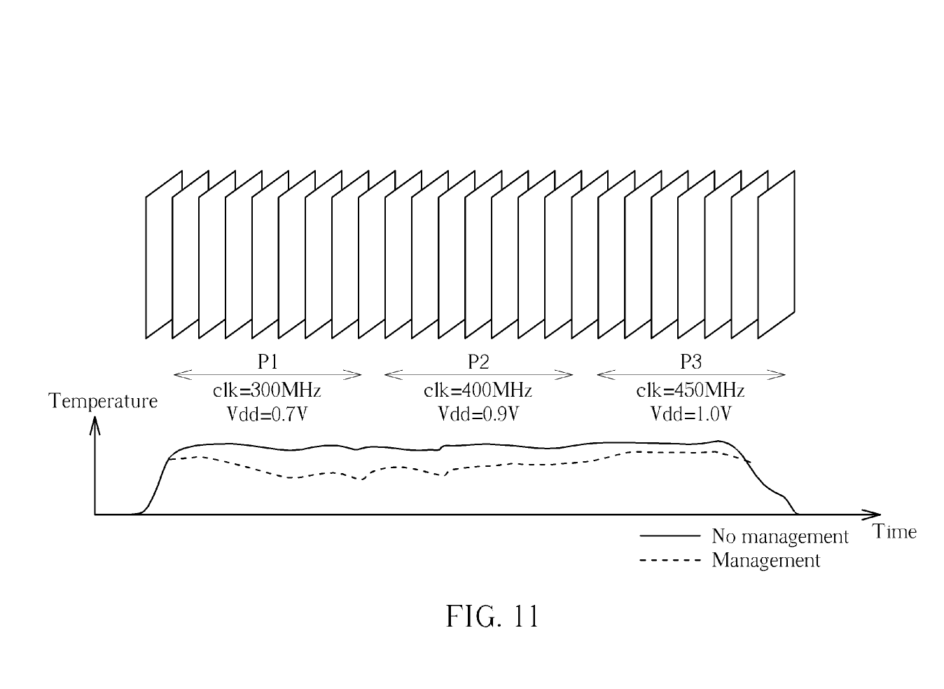

In the embodiment of FIG. 11, the operating voltage is adjusted based on the temperature. As depicted in FIG. 11, the operating voltages Vdd for all periods P1, P2, P3 are initially set to 1.0 v and then adjusted to 0.7V and 0.9V for different periods, thereby the temperatures are reduced (the dotted line). Please note in the embodiment of FIG. 11, the clock rate is also adjusted. However, in one embodiment, the clock rate is maintained at above-mentioned value 500 MHz and only the operating voltage Vdd is adjusted. Also, in the embodiment of FIG. 11, the operating voltages Vdd may be lower than the initial operating voltage Vdd set in the embodiment of FIG. 9. For example, the operating voltages Vdd in FIG. 11 can be 1.0 v, 0.9 v, 0.7 v.

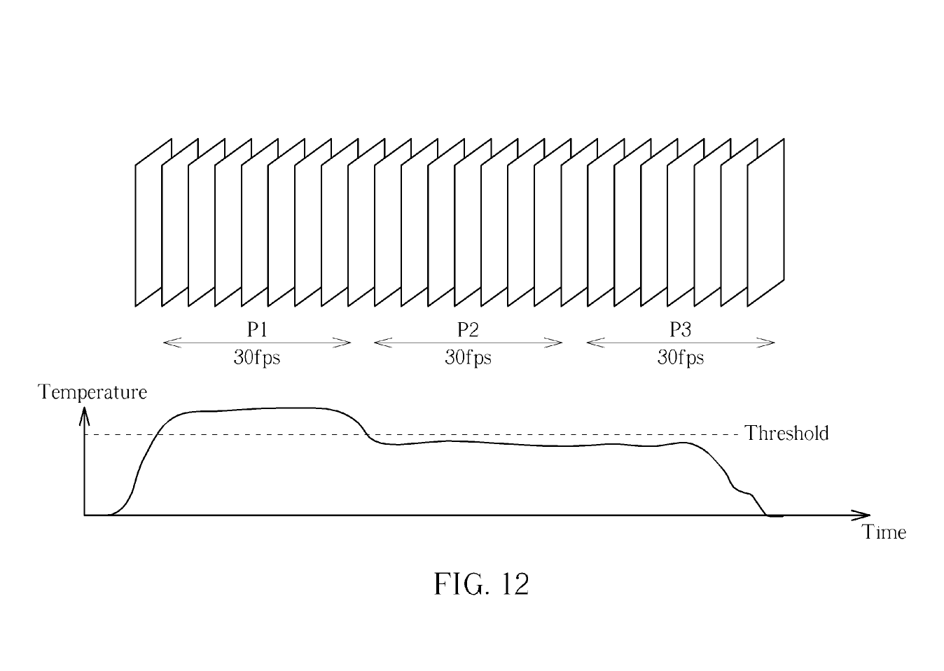

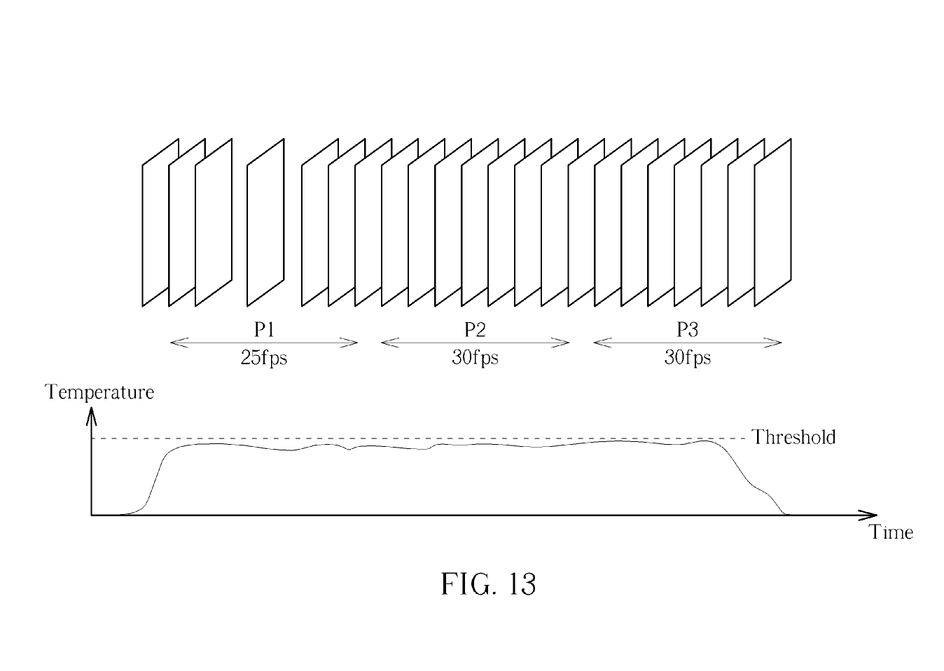

In the embodiments of FIG. 12 and FIG. 13, the frame rate for the display panel to display is adjusted based on the temperature. As depicted in FIG. 12, the frame rates for each period P1, P2, P3 are all 30 fps, and the temperature has a high value over a temperature threshold value. In FIG. 13, the frame rate of the period P1 is reduced to 25 fps, for example, via dropping frames. Thereby the temperature is lower than the temperature threshold value correspondingly.

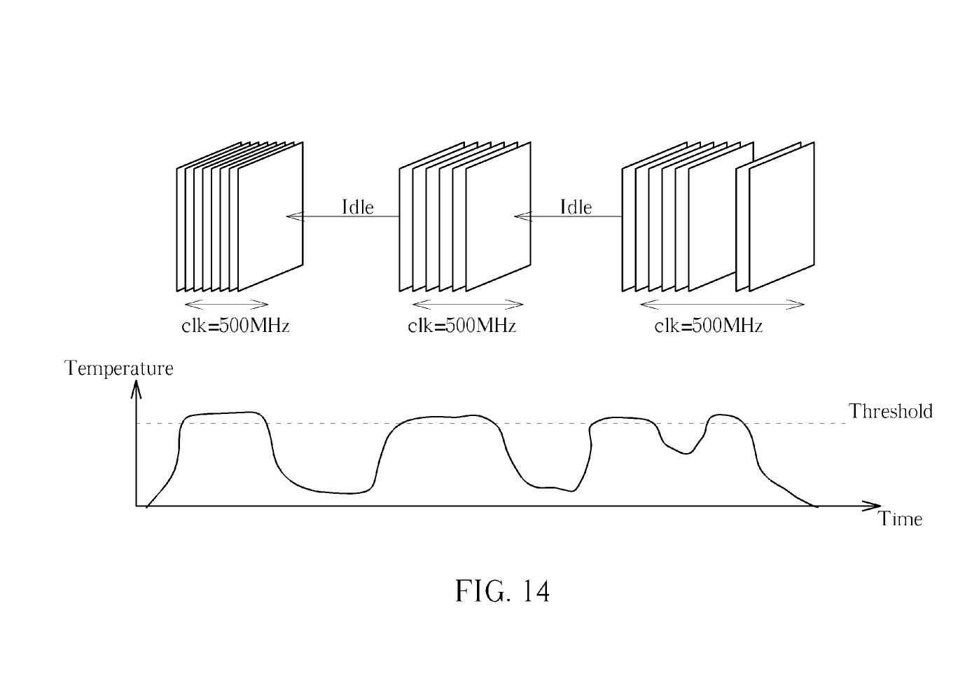

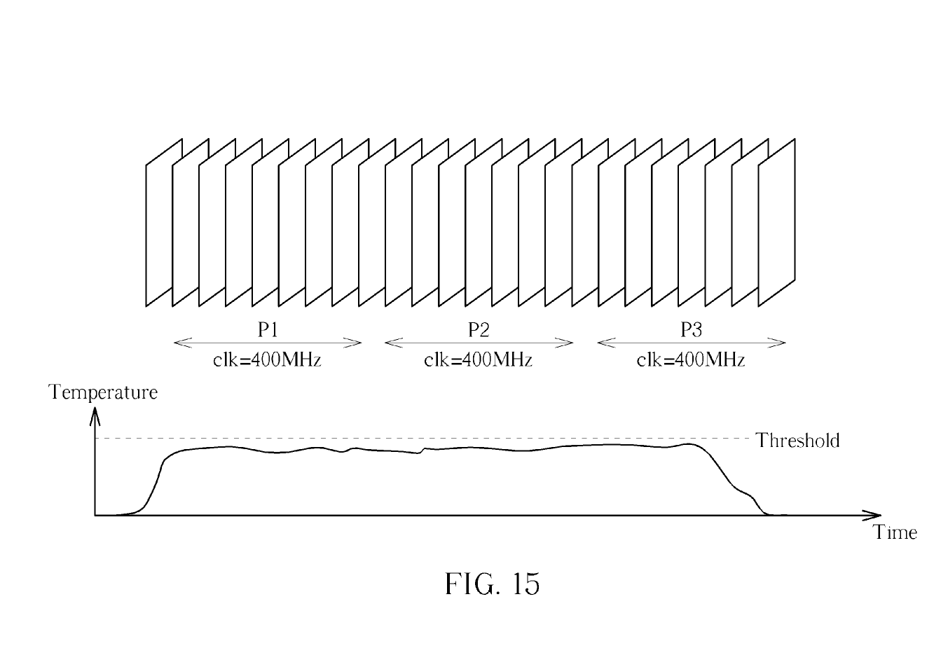

In the embodiments of FIG. 14 and FIG. 15, the operating speed of at least one second device of the image/video processing module is adjusted based on the frame rate or the frame resolution (i.e. the device parameter). In FIG. 14, the image/video processing module is set to high resolution or frame rate and the operating speed is not adjusted (500 MHz) such that the temperature may be over a temperature threshold value. In FIG. 15, for such high resolution or frame rate setting, the operating speeds for all periods P1, P2, P3 (not limited to all periods, however) are adjusted to 400 MHz, such that the temperature is lower than the temperature threshold value correspondingly.

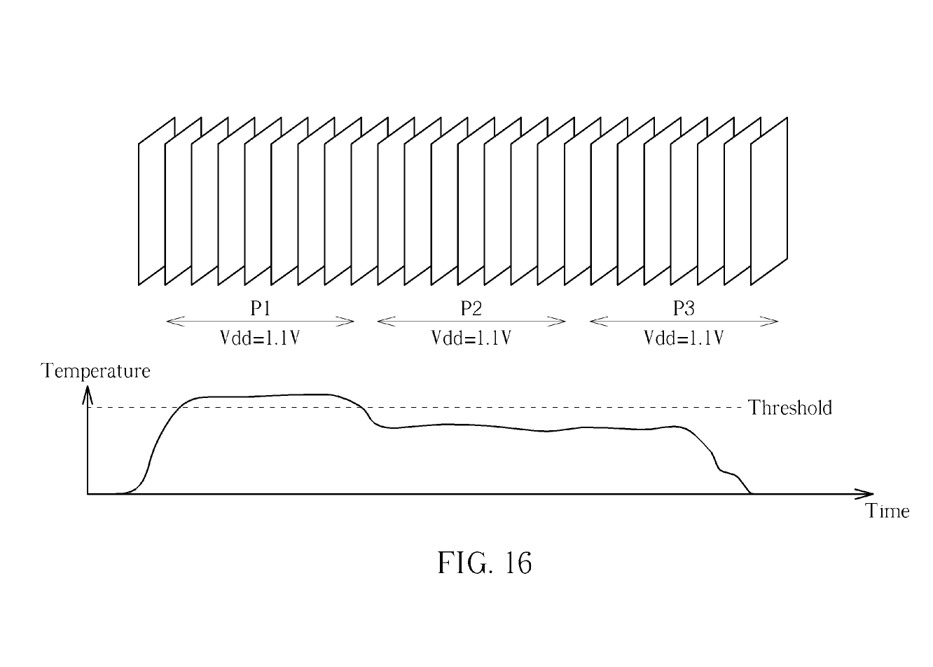

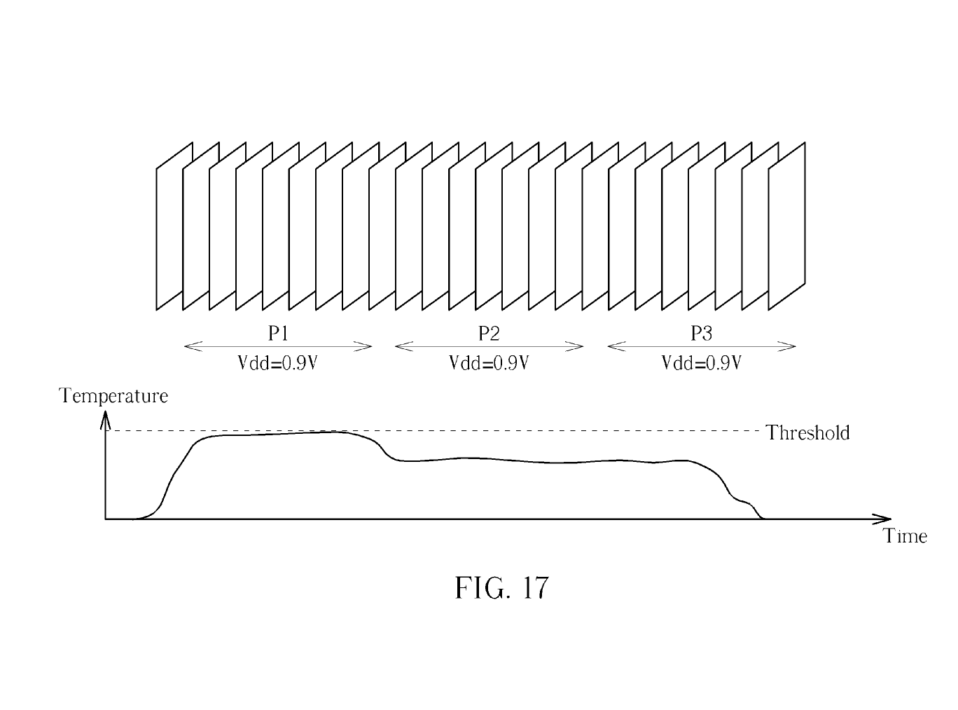

In the embodiments of FIG. 16 and FIG. 17, the operating voltage is adjusted based on the frame rate (i.e. the device parameter) or the frame resolution (i.e. the device parameter). In FIG. 16, the image/video processing module is set to high resolution or frame rate and the operating voltage is not adjusted (1.1V), such that the temperature has high values over a threshold. In FIG. 17, for such high resolution or frame rate setting, the operating voltage for all periods (not limited to all periods, however) P1, P2, P3 are adjusted to 0.9V, such that the temperature is lower than the temperature threshold value correspondingly.

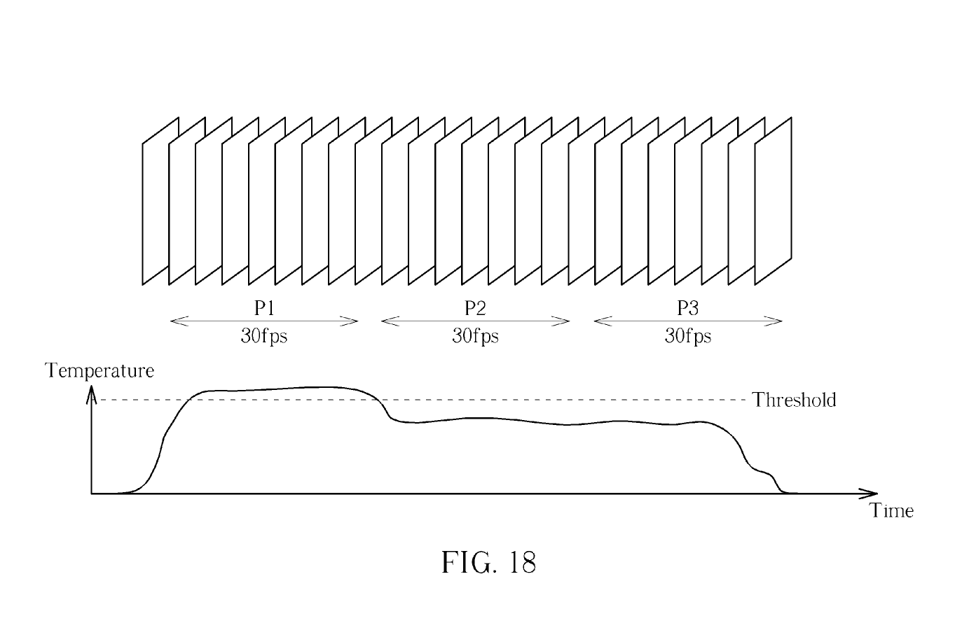

In the embodiments of FIG. 18 and FIG. 19, the frame rate for the display panel to display is adjusted based on the frame resolution (i.e. the device parameter). In FIG. 18, the image/video processing module is set to high resolution and the frame rate is not adjusted (30 fps for all periods P1, P2, P3) such that the temperature may be over a temperature threshold value. In FIG. 19, for such high resolution setting, the frame rates for all periods P1, P2, P3 (not limited to all periods, however) are adjusted to 25 fps, thereby the temperature is lower than the temperature threshold value correspondingly.

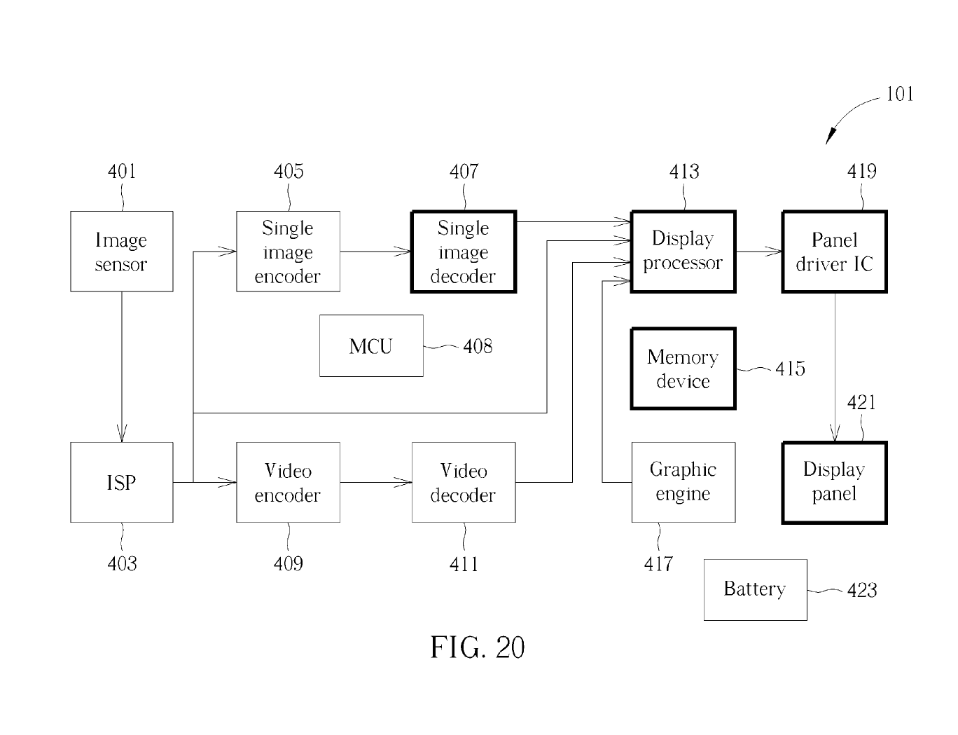

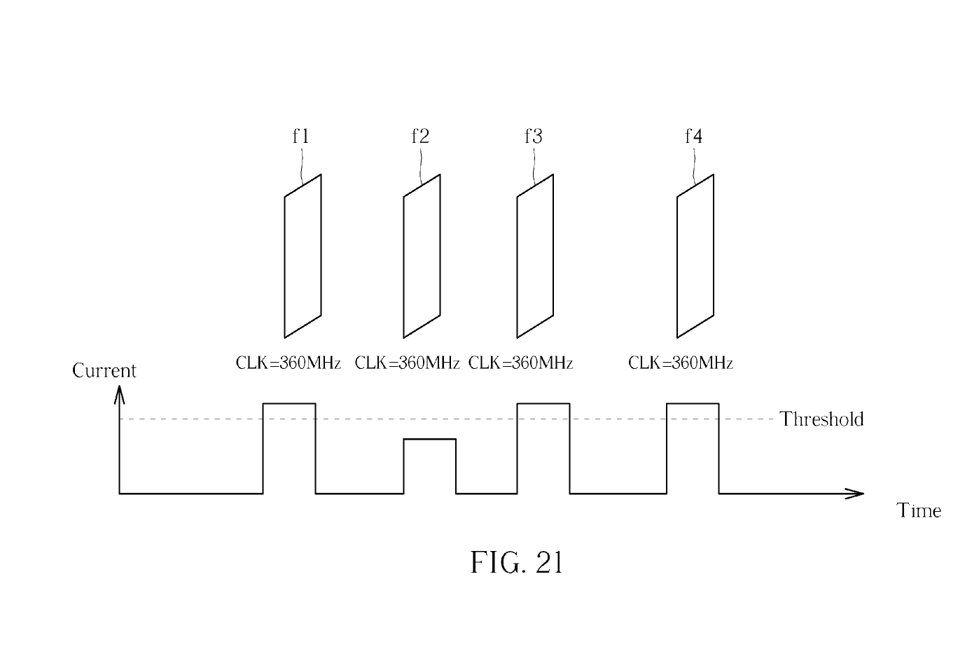

If the image/video processing module is applied to process an image rather than video data, the devices that tend to generate thermal may include: the image decoder 407, the display processor 413, the memory device 415, the panel driver IC 419, the display panel 421 or combination thereof, as depicted in FIG. 20. Therefore, these devices are applied as examples in the embodiments depicted in FIG. 21-FIG. 29. Please note these examples are only for explaining and do not mean to limit the scope of the present invention.

Please refer to FIG. 5A and FIG. 5B again, the steps depicted in FIG. 5A and FIG. 5B and related examples can be applied to the embodiment depicted in FIG. 20. However, please note if the step 507 is applied to the embodiment depicted in FIG. 20, the step 507 measures or receives the device parameter corresponding to at least one of: the image decoder 407, the display processor 413, the memory device 415, the panel driver IC 419 and the display panel 421, which are marked in FIG. 20.

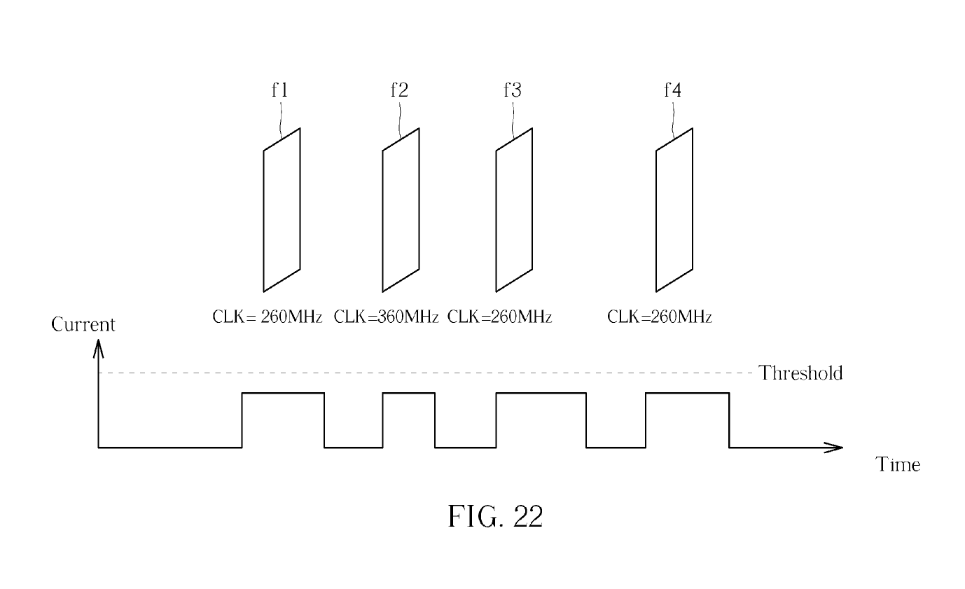

In the embodiments of FIG. 21 and FIG. 22, the operating speed for at least one second device of the image/video processing module is adjusted via adjusting the clock rate thereof, based on the current value (i.e. the device parameter). In FIG. 21, the clock rate is not adjusted (360 MHz) such that the current value may be over a current threshold value. In FIG. 22, the clock rates corresponding to the timing for processing frames f1, f3 and f4 are adjusted to 260 MHz, thereby the current values corresponding to the timing for processing frames f1, f3 and f4 are lower than the current threshold value correspondingly.

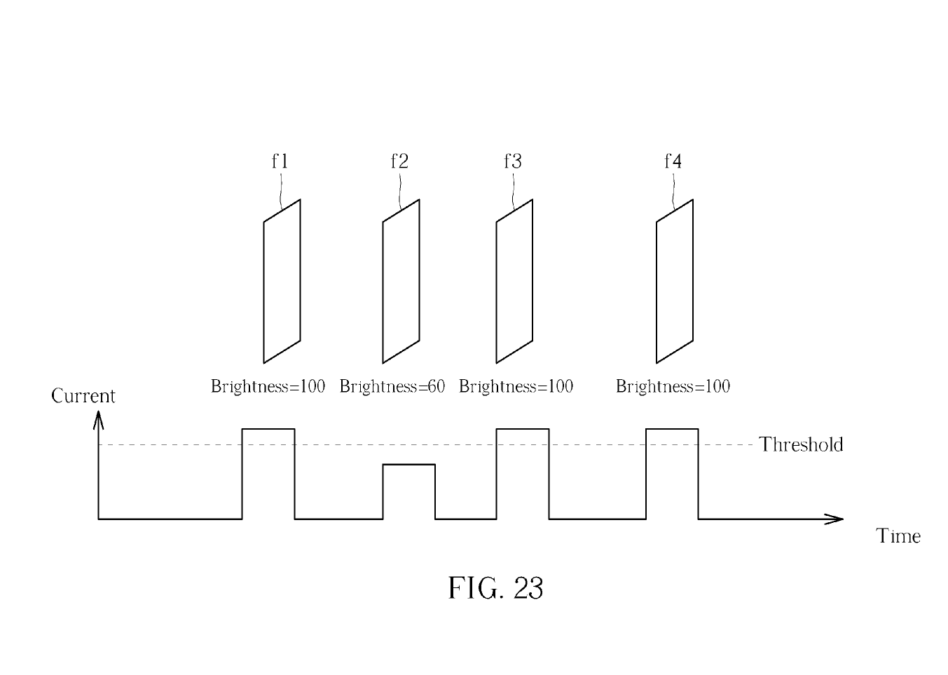

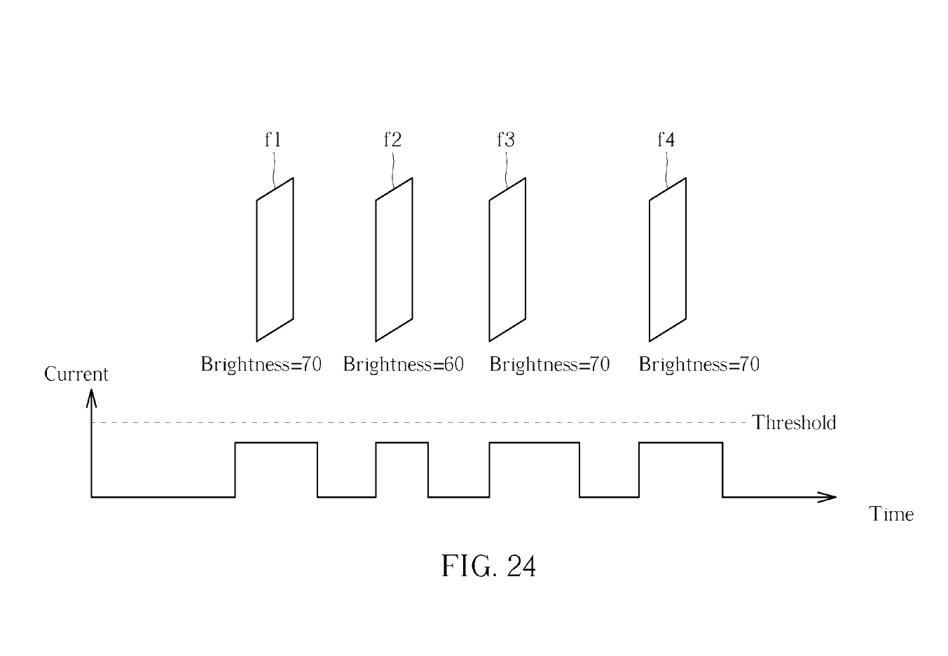

In the embodiments of FIG. 23 and FIG. 24, the brightness value for the display panel is adjusted based on the current value (i.e. the device parameter). In FIG. 23, if the display panel displays frames with high brightness values (e.g. 100), such as frames f1, f3 and f4, the corresponding current values are over the current threshold value. In FIG. 24, the brightness values for frames f1, f3 and f4 are adjusted to 70, thereby the corresponding current values are lower than the current threshold value correspondingly.

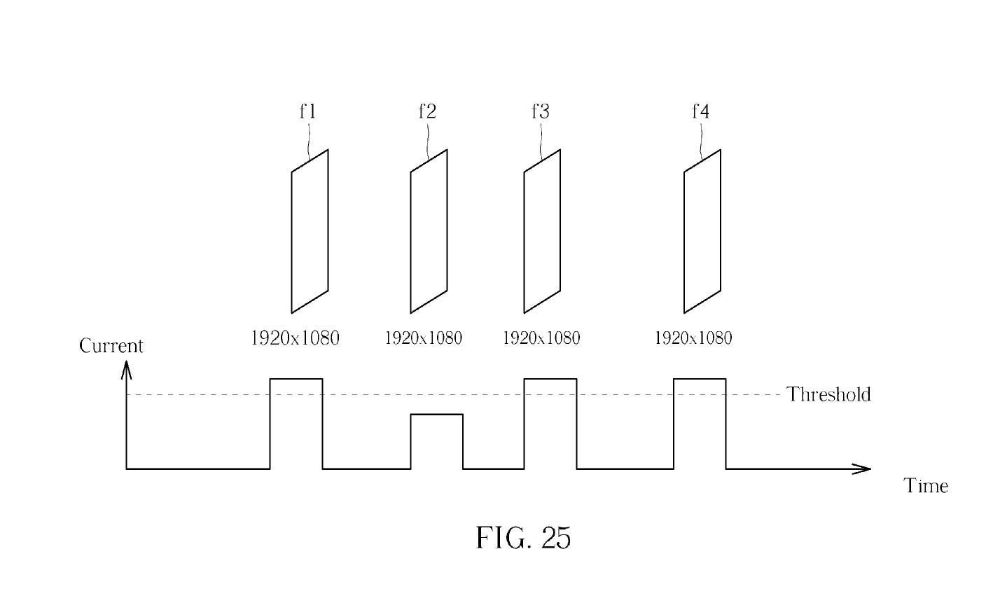

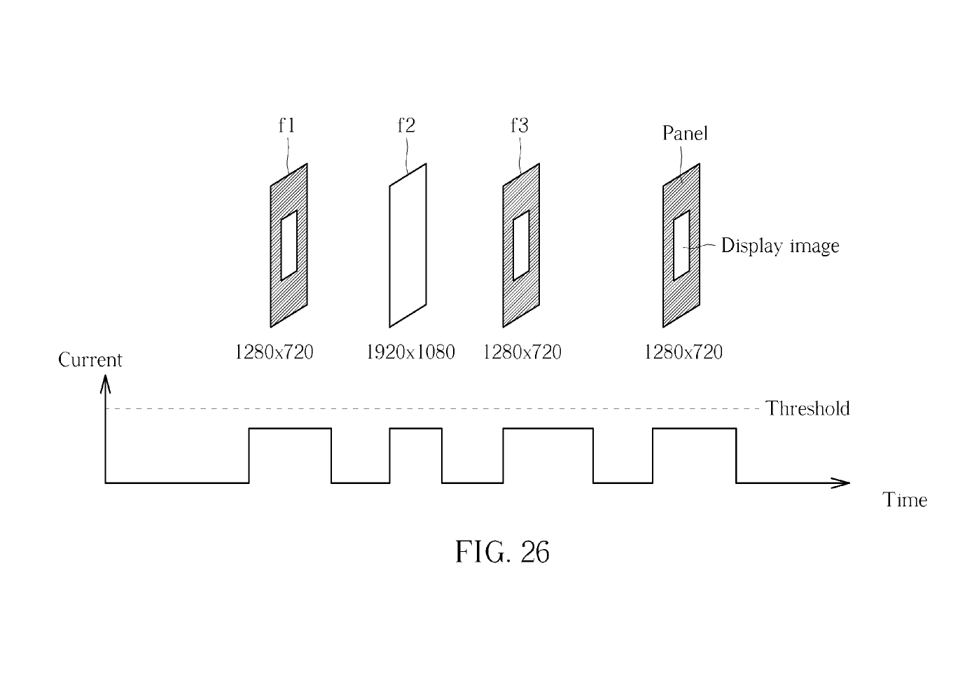

In the embodiments of FIG. 25 and FIG. 26, the configuration about the frame resolution for the display processor or the panel driver IC is adjusted based on the current value (i.e. the device parameter). In FIG. 25, frames f1, f3, and f4 with high frame resolutions (e.g. 1920×1080) are displayed with the current values over the current threshold value. In FIG. 26, the frame resolutions for the frames f1, f3 and f4 are adjusted to 1280×720, thereby the corresponding current values are lower than the current threshold value correspondingly.

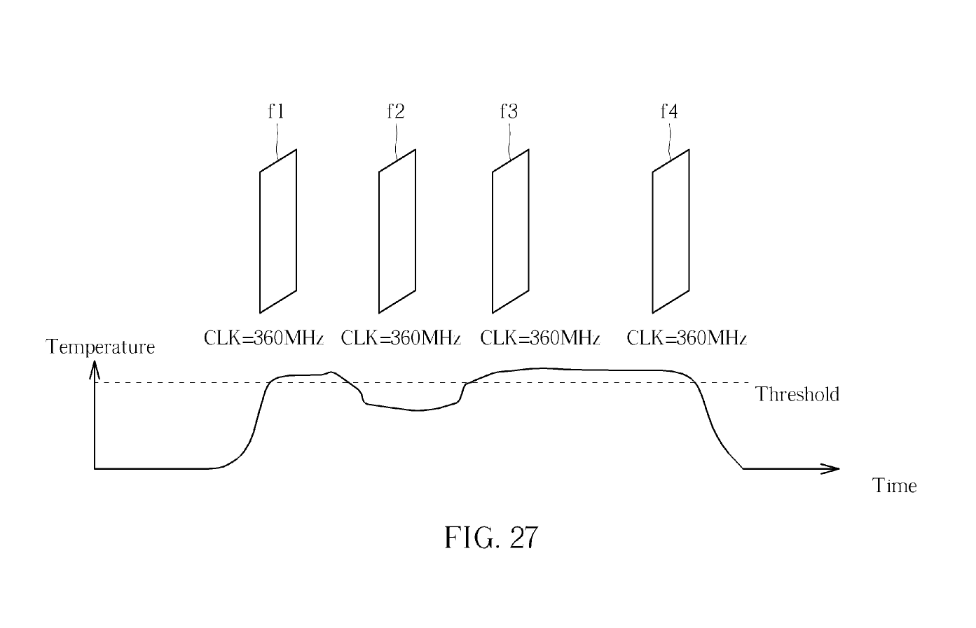

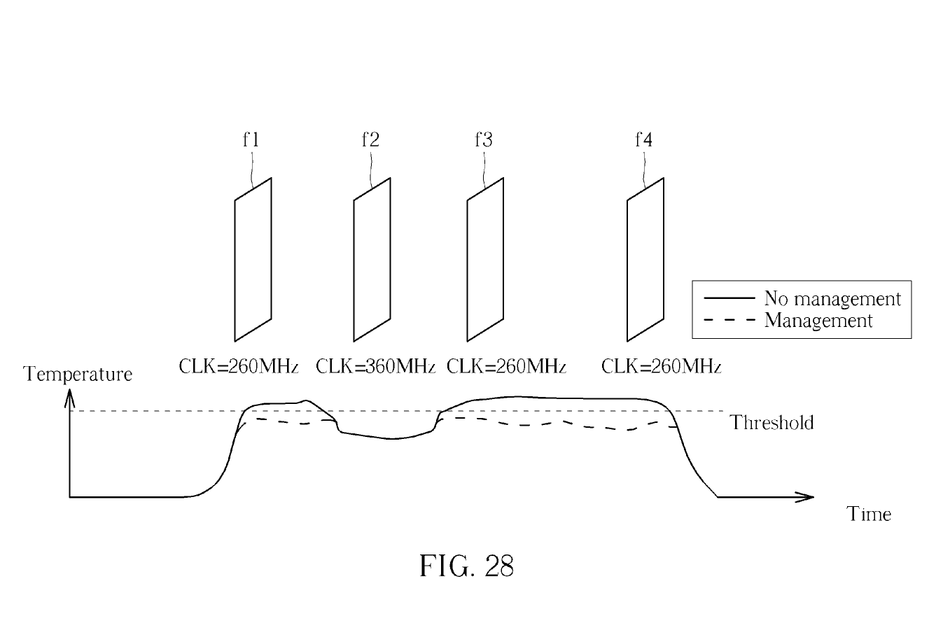

In the embodiments of FIG. 27 and FIG. 28, the operating speed for at least one second device of the image/video processing module is adjusted via adjusting the clock rate thereof, based on the temperature (i.e. the device parameter). In FIG. 27, the clock rate is not adjusted (360 MHz), such that the temperature may be over a temperature threshold value. In FIG. 28, the clock rates corresponding to the timing for processing frames f1, f3 and f4 are adjusted to 260 MHz, thereby the temperature corresponding to the timing for processing frames f1, f3 and f4 are lower than the temperature threshold value correspondingly.

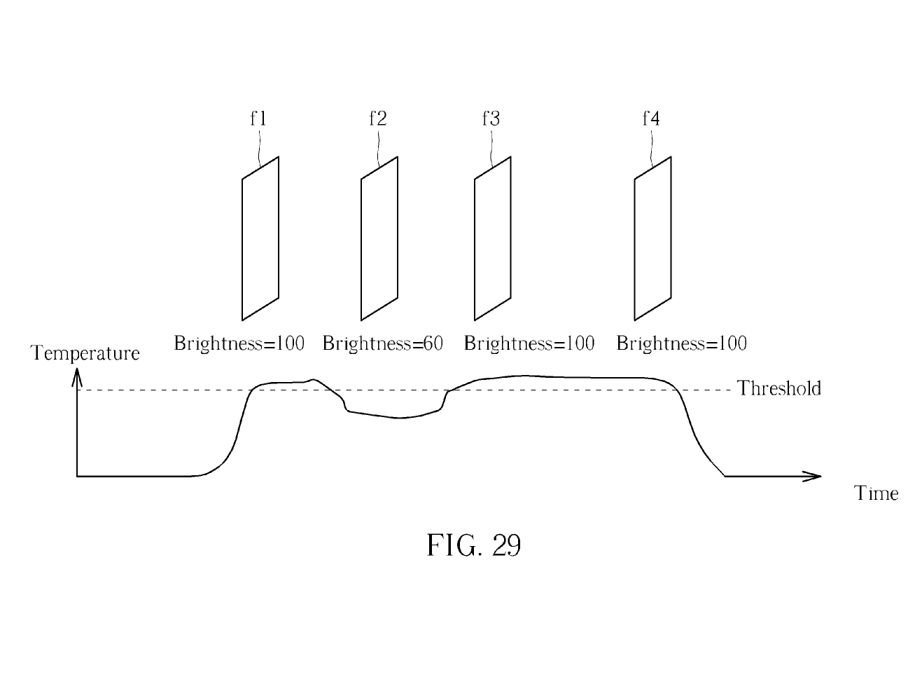

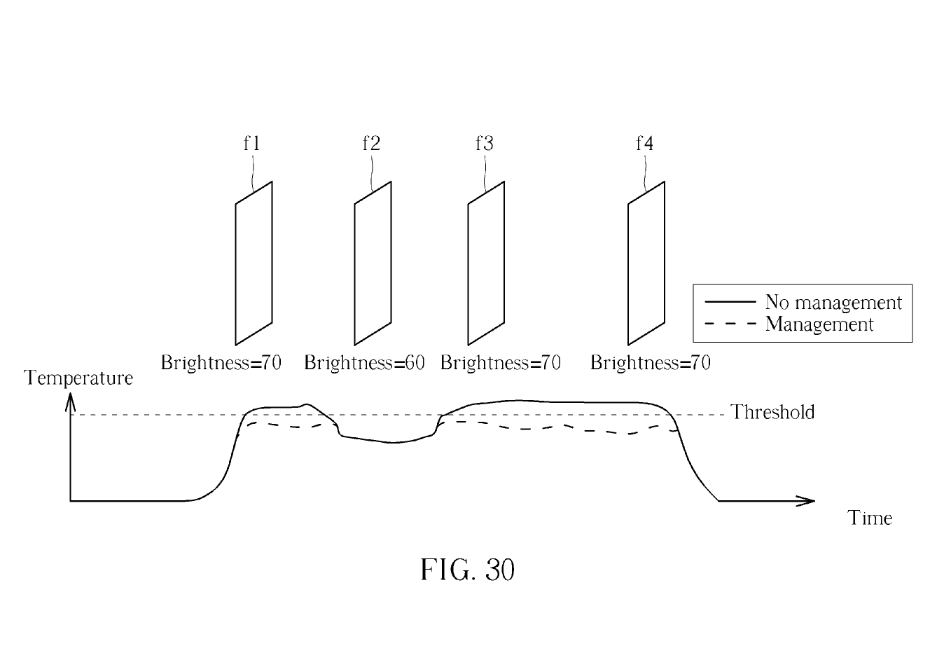

In the embodiments of FIG. 29 and FIG. 30, the brightness value of the display panel is adjusted based on the temperature (i.e. the device parameter). In FIG. 29, the brightness value is not adjusted (e.g. 100), such that the temperature may be over a temperature threshold value. In FIG. 30, the brightness value for displaying frames f1, f3 and f4 are adjusted to 70, thereby the temperature corresponding to the timing for displaying frames f1, f3 and f4 are lower than the temperature threshold value correspondingly.

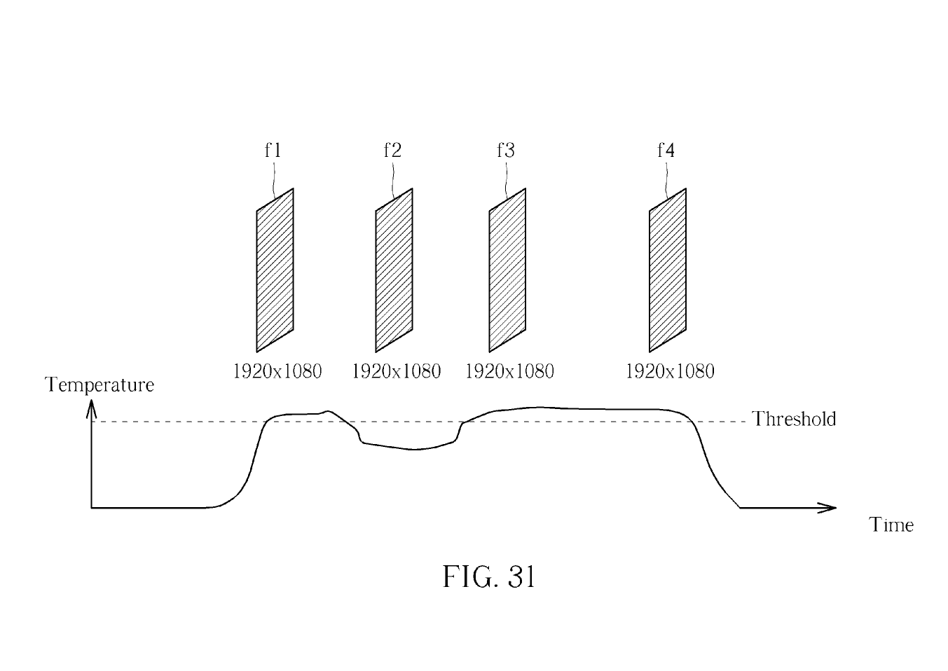

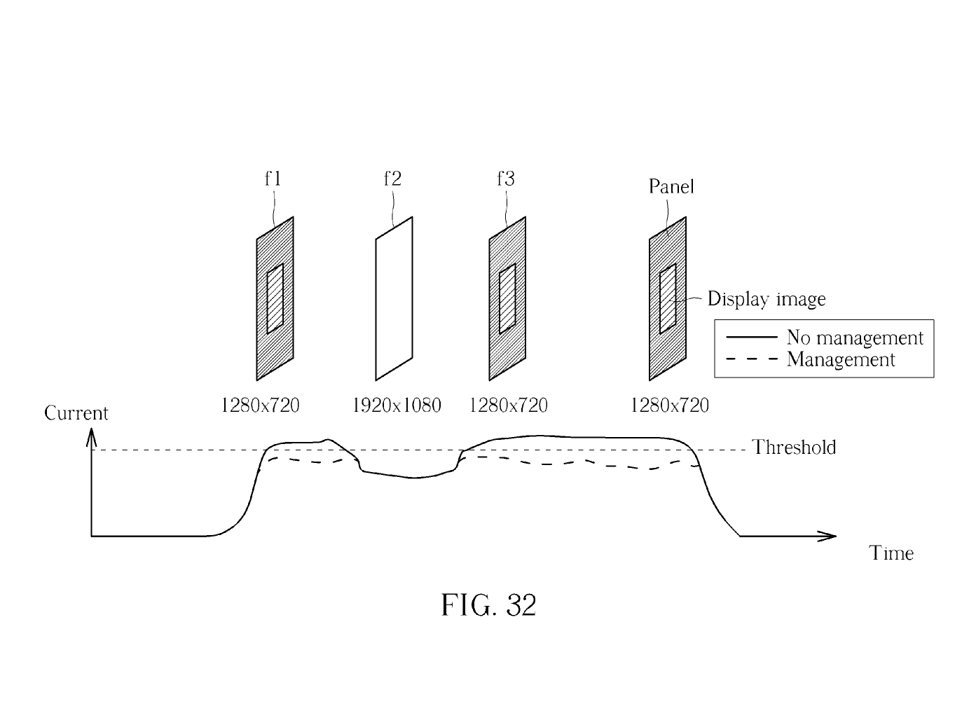

In the embodiments of FIG. 31 and FIG. 32, the configuration about the frame resolution for the display processor or the panel driver IC is adjusted based on the temperature. In FIG. 31, if frames f1, f3, and f4 with high frame resolutions (e.g. 1920×1080) are displayed, the temperature may be over the temperature threshold value. In FIG. 32, the frame resolutions for the frames f1, f3 and f4 are adjusted to 1280×720, thereby the temperature corresponding to the timing for displaying frames f1, f3 and f4 are lower than the temperature threshold value correspondingly.

In above-mentioned embodiments, the operating parameters are adjusted based on the temperature or parameters representing or indicating the temperature (e.g. current). However, as above-mentioned the operating parameters can be adjusted according to a device parameter related to the temperature. In one embodiment, the operating speed of the image decoder or any other device of the image/video processing module are adjusted according to the frame resolution, since displaying frames with high resolutions may generate much thermal. In another embodiment, the brightness value of the display panel is adjusted according to the frame resolution.

In view of above-mentioned embodiments, a thermal management method for controlling a temperature of an image/video processing module can be acquired. The method comprises: (a) acquiring at least one device parameter corresponding to at least one first device of the image/video processing module; and (b) adjusting at least one operating parameter for at least one second device of the image/video processing module according to the device parameter. The device parameter and the operating parameter can have various combinations, depending on which device of the image/video processing module is adjusted, as above mentioned.

In view of above-mentioned embodiments, the temperature can be controlled via adjusting only a few devices of the image/video processing module, thus the performance for whole electronic apparatus would not greatly decrease. In some embodiments, the image/video processing module may be implemented as part of a device for displaying a photo gallery, video playback or providing any other image/video related functions.

Those skilled in the art will readily observe that numerous modifications and alterations of the device and method may be made while retaining the teachings of the invention. Accordingly, the above disclosure should be construed as limited only by the metes and bounds of the appended claims.

1. A thermal management method comprising:
(a) acquiring at least one device parameter corresponding to a first device of an image/video processing module; and
(b) adjusting at least one operating parameter for a second device of the image/video processing module according to the device parameter to control a temperature of the image/video processing module.

2. The thermal management method of claim 1, further comprising:
determining at least one temperature corresponding to the first device of the image/video processing module according to the device parameter;
wherein the step (b) adjusts the operating parameter according to the temperature corresponding to the first device of the image/video processing module.

3. The thermal management method of claim 2, further comprising:
measuring an environment temperature; and
adjusting the determined temperature corresponding to the first device of the image/video processing module based on the environment temperature to generate an adjusted temperature;
wherein the step (b) adjusts the operating parameter according to the adjusted temperature.

4. The thermal management method of claim 1,
wherein the image/video processing module comprises at least one of following devices: an image decoder, a video decoder, a display processor, a memory device, a panel driver IC and a display panel.

5. The thermal management method of claim 1, wherein the device parameter comprises at least one of: a temperature corresponding to the first device, a current value, a signal delay value, a frame rate, an exposure value, a frame resolution, a power consumption value, and an operating speed.

6. The thermal management method of claim 1, wherein the operating parameter comprises at least one of: an operating speed, a frame rate, an exposure value, a frame resolution, a brightness value, and an operating voltage.

7. The thermal management method of claim 1, wherein the device parameter comprises a current value, and the operating parameter comprises an operating speed or an operating voltage.

8. The thermal management method of claim 1, wherein the device parameter comprises a frame resolution or a frame rate, and the operating parameter comprises an operating speed or an operating voltage.

9. The thermal management method of claim 1, wherein the device parameter comprises a frame resolution, and the operating parameter comprises a frame rate or a brightness value.

10. The thermal management method of claim 1, wherein the device parameter comprises a current value, and the operating parameter comprises a brightness value or a frame resolution.

11. The thermal management method of claim 1, wherein the operating parameter comprises a configuration parameter.

12. The thermal management method of claim 1, wherein the device parameter comprises a consequence parameter or a configuration parameter, and the operating parameter comprises an operating speed or an operating voltage.

13. An electronic system with a thermal control mechanism, comprising:
an image/video processing module, configured to process at least one image or video data;
a parameter acquiring device, configured to acquire at least one device parameter corresponding to a first device of the image/video processing module; and
a thermal management device, configured to adjust at least one operating parameter for a second device of the image/video processing module according to the device parameter to control a temperature of the image/video processing module.

14. The electronic system of claim 13, wherein the thermal management device further determines at least one temperature corresponding to the first device of the image/video processing module according to the device parameter, and adjusts the operating parameter according to the temperature corresponding to the first device of the image/video processing module.

15. The electronic system of claim 14, wherein the thermal management device further measures an environment temperature, and adjusts the determined temperature corresponding to the first device of the image/video processing module based on the environment temperature to generate an adjusted temperature; wherein the thermal management device adjusts the operating parameter according to the adjusted temperature.

16. The electronic system of claim 13,
wherein the image/video processing module comprises at least one of following devices: an image decoder, a video decoder, a display processor, a memory device, a panel driver IC and a display panel.

17. The electronic system of claim 13, wherein the device parameter comprises at least one of: a temperature corresponding to the first device, a current value, a signal delay value, a frame rate, an exposure value, a frame resolution, a power consumption value, and an operating speed.

18. The electronic system of claim 13, wherein the operating parameter comprises at least one of: an operating speed, a frame rate, an exposure value, a frame resolution, a brightness value, and an operating voltage.

19. The electronic system of claim 13, wherein the device parameter comprises a current value, and the operating parameter comprises an operating speed or an operating voltage.

20. The electronic system of claim 13, wherein the device parameter comprises a frame resolution or a frame rate, and the operating parameter comprises an operating speed or an operating voltage.

21. The electronic system of claim 13, wherein the device parameter comprises a frame resolution, and the operating parameter comprises a frame rate or a brightness value.

22. The electronic system of claim 13, wherein the device parameter comprises a current value, and the operating parameter comprises a brightness value or a frame resolution.

23. The electronic system of claim 13, wherein the operating parameter comprises a configuration parameter.

24. The electronic system of claim 13, wherein the device parameter comprises a consequence parameter or a configuration parameter, and the operating parameter comprises an operating speed or an operating voltage.
